(19) United States
(12) Patent Application Publication
(10) Pub. No.: US 2011/0236586 A1
(43) Pub. Date: Sep. 29, 2011

(54) Method for Sealing Surfaces

(75) Inventors: Andreas Bauer, Kirchdorf (DE); Volker Stanjek, Ampfing (DE)

(73) Assignee: Wacker Chemie AG

(21) Appl. No.: 13/129,754

(22) PCT Filed: Nov. 9, 2009
(86) PCT No.: PCT/EP09/64808

§ 371 Date: May 17, 2011

(30) Foreign Application Priority Data
Nov. 18, 2008 (DE) 10 2008 043 825.1

(51) Int. Cl. C09D 171/08; C09D 7/12; B05D 3/02

(52) U.S. Cl. 427/387; 524/612; 524/425; 524/449; 524/451

(57) ABSTRACT

The invention relates to a method for sealing surfaces using single-component, moisture-curing coating compositions (C) containing 5 to 75 wt % of one or more silane-terminated polymers (P) having end groups of the formula (I) —O—C(=O) —NH—A—Si (OR¹) (I), wherein A stands for a linear or branched alkylene group having 1 to 10 carbon atoms, R¹ stands for a linear or branched, possibly halogenated alkyl group having 1 to 10 carbon atoms, R² stands for a linear or branched, possibly halogenated alkyl group having 1 to 10 carbon atoms, and X is 1, 2, or 3, 1 to 80 wt % of one or more fillers (F), 0.1 to 10 wt % of one or more water catchers (W), 0.01 to 5 wt % of one or more hardening catalysts (K), 0.01 to 10 wt % of one or more adhesion promoters (A), and possibly further substances common in moisture-curing coating compositions, wherein the weight amounts total 100%.

### CROSS REFERENCE TO RELATED APPLICATIONS

This application is the national phase filing of international patent application No. PCT/EP2009/064808, filed 9 Nov. 2009, and claims priority of German patent application number 10 2008 043 825.1, filed 18 Nov. 2008, the entireties of which applications are incorporated herein by reference.

### FIELD OF THE INVENTION

The invention relates to a method for sealing surfaces using a one-component, moisture-curing coating composition which is isocyanate-free and bitumen-free. The invention relates more particularly to a method for sealing exterior and interior building surfaces, roofs, and the like.

### BACKGROUND OF THE INVENTION

It is massively important to seal organic and inorganic building materials such as concrete or wood internally and externally on buildings or on the roof against the penetration of water, in order to prevent destruction of the materials over time.

On complex roofs with copious detailing, many sealing materials frequently used in the past, such as bitumen sheets, have almost entirely disappeared, on account of the very great difficulty of sealing angles and edges. This problem was subsequently solved by the use of molten bitumen, but only at the expense of other hazards for the operator, through toxic vapors and through operation with the very hot liquid. VOC limitations and toxicological considerations have seen other solutions formerly in use, such as solventborne bitumen systems, being replaced by different technologies.

Nowadays, water-based coating materials such as acrylate-modified or polymer-modified bitumen emulsions are primarily used, although one- and two-component polyurethane systems continue to play a significant part, in roof sealing, for example.

A great disadvantage of aqueous emulsions is the physical drying of the materials, which becomes very slow particularly below a temperature of 15° C. On the other hand, drying at the surface is comparatively rapid at more than 25° C., with the associated possibility of inclusions of water and, subsequently, formation of bubbles. In this way, weak points are formed in the coating, and can lead to leaks.

One-component, polyurethane-based sealing systems commonly comprise large amounts of solvent in order to lower the viscosity to an acceptable level for brush application or roll application in the roof region. Two-component polyurethane systems are very expensive by comparison and necessitate a complicated application technology. All polyurethane sealing systems include isocyanate compounds, which are highly toxic and whose use in virtually all home applications, and also in many professional applications, is viewed critically.

RTV-1 silicone coating formulations such as acetate systems or oxime systems give off elimination products in the course of curing that have a poor odor or are even harmful to health, such as acetic acid or oxime, for example. Other disadvantages of these materials are the poor adhesion to a large number of building materials, the poor recoatability, and the inadequate weathering stability.

One-component, moisture-curing coating compositions based on MS polymers (silane-terminated polyethers prepared by a particular process) are known in the form of sealing materials for application in the construction segment from EP 1 695 989 A, WO 2007/093382, and WO 2008/077510. Common to all MS polymer formulations is the need for large amounts of tin catalysts for a reasonable skinover time and for passable through-curing. In the last stage of the operation for preparing MS polymer, the silyl end groups are introduced by way of a hydrosilylation reaction, as described in EP 1 695 989 A, for example. As is known from EP 1 036 807 A, the efficiency of this end termination in the preparation procedure is relatively poor, at no more than 85%, for the conventional, commercially available MS polymers. Ultimately, however, all end groups which are not terminated are unreactive, and form “dead chain ends”. Consequently, cured coating formulations based on MS polymers always possess a substantial residual tack, resulting in rapid soiling and being unwanted accordingly—particularly in the case of applications in the roof region. In addition, in order to achieve acceptable mechanical properties, MS polymer-based formulations have to contain more than 25% by weight of MS polymers, as a comparatively expensive formulating ingredient, as is known from WO2007/093382.

### SUMMARY OF THE INVENTION

The object was to provide a method for sealing surfaces, more particularly for sealing exterior and interior building surfaces, roofs, and the like, using one-component, moisture-curing, isocyanate-free and bitumen-free coating compositions which no longer have the disadvantages described above. The object more particularly was to provide a method for sealing surfaces against the penetration of water or water vapor. The coating compositions are preferably to contain only very small amounts of metal-containing catalysts, such as tin-containing catalysts, and more particularly no metal-containing catalysts at all, and are to work with comparatively small amounts of crosslinkable polymers, and are to cure to tack-free coatings. The object is achieved by means of the invention.

### DETAILED DESCRIPTION OF THE INVENTION

The invention provides a method for sealing surfaces using one-component, moisture-curing coating compositions (C) comprising 5% to 75% by weight of one or more silane-terminated polymers (P) having end groups of the formula (I)

˜O—C (=O) —NH—A—Si (OR¹)ₓR²₃₋ₓ (I),

in which

A is a linear or branched alkylene group having 1 to 10 carbon atoms,

R¹ is a linear or branched, optionally halogenated alkyl group having 1 to 10 carbon atoms,

R² is a linear or branched, optionally halogenated alkyl group having 1 to 10 carbon atoms, and

x is 1, 2 or 3,

1% to 80% by weight of one or more fillers (F),

0.1% to 10% by weight of one or more water scavengers (W),

0.01% to 5% by weight of one or more curing catalysts (K),

0.01% to 10% by weight of one or more adhesion promoters (A), and optionally further substances customary in moisture-curing coating compositions, preferably plasticizers, rheological additives, stabilizers, fungicides, pigments, flame retardants or solvents, the amounts by weight adding up to 100%.

A is preferably a propylene or methylene group. The methylene group is particularly preferred on account of the high moisture reactivity of the corresponding polymer (P). Formulations comprising polymers (P) in which A is a methylene group have the advantage that they can be cured preferably without metal catalysts and more particularly without tin-comprising catalysts.

Examples of alkyl radicals R¹ and R² are, in each case independently of one another, the methyl, ethyl, n-propyl, isopropyl, n-butyl, isobutyl, tert-butyl, pentyl, isopentyl, neopentyl, tert-pentyl radical, hexyl radicals, such as n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, and decyl radicals, such as the n-decyl radical.

Examples of halogenated alkyl radicals R¹ and R² are, in each case independently of one another, the 3,3,3-trifluoro-n-propyl radical, the 2,2,2,2′,2′,2′-hexafluoroisopropyl radical, and the heptafluoroiso-propyl radical.

R¹ is preferably a methyl or ethyl radical.

R² is preferably a methyl radical.

x is preferably 2 or 3.

It will be appreciated that it is also possible to use mixtures of two or more polymers (P) having end groups of the formula (I) in which A, R¹, R², and x have different definitions, examples being polymers (P) in which R¹ is a methyl and ethyl radical and/or A is a propylene and methylene group.

Examples of polymers (P) which comprise the end groups of the formula (I) are preferably polyesters, polyethers, polyalkylene or polyacrylate. Particularly preferred is a linear polyether, such as a polypropylene oxide. The average molecular weights Mₙ of the polymers (P) are preferably 2000 to 25 000 g/mol, more preferably 4000 to 20 000 g/mol, and very preferably 10 000 to 19 000 g/mol. The viscosity of the polymers (P) is preferably at least 0.2 Pa·s at 20° C., more preferably at least 1 Pa·s at 20° C., very preferably at least 5 Pa·s at 20° C., and preferably not more than 100 Pa·s at 20° C., more preferably not more than 40 Pa·s at 20° C. The polymers (P) are prepared preferably by methods as described in WO 2006/136261, EP 1 535 940 Al or WO 2007/131986.

Serving as a basis of the coating compositions of the invention are preferably silane-terminated polyethers having dimethoxymethylsilyl, trimethoxysilyl, diethoxymethylsilyl or triethoxysilyl end groups of the formula (I) with different viscosities.

Surprisingly, the coating formulations (C) of the invention, based on silane-terminated polymers (P), cure to completely tack-free coatings and thereby differ significantly from all silane-crosslinking sealing systems of the kind described in the prior art.

It has additionally been found, surprisingly, that the coating formulations (C) of the invention, based on silane-terminated polymers (P), exhibit good through-curing of comparatively low levels of polymers (P), and that the cured coating possesses sufficient mechanical properties. The coating compositions (C) comprise preferably not more than 25%, more preferably not more than 20%, and very preferably not more than 15%, by weight, of polymers (P), and preferably at least 5% by weight of polymer (P).

A further advantage of the coating compositions (C) of the invention lies in the fact that in order to achieve a sufficient cure rate they require very small amounts, or none at all, of metal-containing catalysts, more particularly tin-containing catalysts.

Examples of fillers (F) are calcium carbonate, barium sulfate, talc, mica, kaolin, silica, quartz, heavy spar, and carbon black.

One particularly preferred filler (F) is calcium carbonate. Preferred types of calcium carbonate are ground or precipitated and optionally surface-treated with fatty acids such as stearic acid or salts thereof. The composition (C) comprises preferably at least 10% by weight, more preferably at least 20% by weight, and preferably not more than 75% by weight, more preferably not more than 70% by weight, and very preferably not more than 65% by weight of calcium carbonate. Additionally preferred are types of fillers (F) which have a platelet-shaped structure with a high aspect ratio of >2:1, examples being certain classes of talc and of mica. The composition (C) comprises preferably at least 10% by weight, more preferably at least 20% by weight, and preferably not more than 75% by weight, more preferably not more than 70% by weight, and very preferably not more than 65% by weight of these types of fillers (F).

A further preferred filler (F) is silica, more particularly fumed silica. With very particular preference the composition (C) comprises not only silica, more particularly fumed silica, but also other fillers (F), with calcium carbonate being preferred. The composition (C) in that case comprises silica, more particularly fumed silica, in amounts of preferably at least 0.1% by weight, more preferably at least 0.4% by weight, and preferably not more than 10% by weight, more preferably not more than 5% by weight, and calcium carbonate in the amounts indicated above, the amount of fillers (F) together being not more than 80% by weight, based on the total weight of the coating compositions (C).

Another preferred composition (C) is transparent and comprises exclusively silica, more particularly fumed silica, as filler (F), in amounts preferably of 5% to 50% by weight.

Examples of water scavengers (W) are silanes such as vinyltrimethoxysilane, vinyltriethoxysilane, vinylmethyldimethoxysilane, O-methylcarbamatomethylmethyldimethoxysilane, O-methylcarbamatomethyltrimethoxysilane, O-ethylcarbamatomethylmethyldiethoxysilane, O-ethyl-carbamatomethyltriethoxysilane, 3-methacryloyloxy-propyltrimethoxysilane, methacryloyloxymethyltrimethoxysilane, methacryloyloxymethylmethyldimethoxysilane, methacryloyloxymethyltriethoxysilane, methacryloyloxymethylmethyldiethoxysilane, 3-acryloyloxypropyltrimethoxysilane, acryloyloxymethyltrimethoxysilane, acryloyloxymethylmethyldimethoxysilane, acryloylmethyltriethoxysilane, acryloyloxymethylmethyldiethoxysilane and ortho esters, such as 1,1,1-trimethoxyethane, 1,1,1-triethoxyethane, trimethoxymethane, triethoxymethane, and related compounds.

The composition (C) comprises preferably at least 0.1% by weight, more preferably at least 0.5% by weight, and preferably not more than 10% by weight, more preferably not more than 5% by weight, and very preferably not more than 4% by weight of one or more water scavengers (W).

Examples of metal-containing curing catalysts (K) are esters of titanic acid, such as tetrabutyl titanate, tetrapropyl titanate, tetraisopropyl titanate, and titanium tetraacetylacetonato; tin compounds, such as dibutyltin dilaurate, dibutyltin maleate, dibutyltin diacetate, dibutyltin dioctanoate, dibutyltin acetylacetonate, dibutyltin oxides, and corresponding dioctyltin compounds.

Examples of metal-free curing catalysts (K) are basic compounds, such as aminosilanes, examples being 3-aminopropyltrimethoxysilane, 3-aminopropyltriethoxysilane, 3-aminopropylmethyldimethoxysilane, 3-aminopropylmethyldiethoxysilane, N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, N-(2-aminoethyl)-3-aminopropyltriethoxysilane, cyclohexylaminomethyltriethoxysilane, cyclohexylaminomethylmethyldiethoxysilane, cyclohexylaminomethyltriethoxysilane, 3-cyclohexylaminomethyltrimethoxysilane, cyclohexylaminomethyltrimethoxysilane, cyclohexylaminomethylmethyldimethoxysilane, and other organic amines, such as triethylamine, tributylamine, 1,4-diazabicyclo[2,2,2]octane, 1,5-diazabicyclo[4.3.0]-non-5-ene, 1,8-diazabicyclo[5.4.0]undec-7-ene, N,N-bis(N,N-dimethyl-2-aminoethyl)methylamine, N,N-dimethylcyclohexylamine, N,N-dimethylphenylamine, and N-ethylmorpholinine; acidic compounds, such as phosphoric acid and its esters, toluenesulfonic acid, and inorganic acids, such as sulfuric acid and nitric acid.

Preferred curing catalysts (K) are aminosilanes alone or in combination with dialkyltin compounds.

The coating composition (C) comprises preferably one or more curing catalysts (K), preferably metal-free curing catalysts, in amounts of preferably at least 0.01% by weight, more preferably at least 0.05% by weight, and preferably not more than 5% by weight, more preferably not more than 3% by weight.

The coating composition (C) may further comprise one or more tin-containing curing catalysts (K), in amounts of preferably at least 0.01% by weight, more preferably at least 0.02% by weight, and preferably not more than 0.5% by weight, more preferably not more than 0.2% by weight, very preferably not more than 0.1% by weight, the amount of curing catalysts together being not more than 5% by weight, based on the total weight of the coating compositions (C). With particular preference, however, the coating compositions (C) of the invention are completely tin-free.

A tin-free composition of the coatings (C) is accomplished preferably by using polymers (P) having end groups of the formula (I) in which A is a methylene group. The use of tin-free coating compositions (C) on the basis of these polymers therefore constitutes one particularly preferred embodiment of the invention.

The curing catalysts (K) may be used both in pure form and in mixtures.

Examples of adhesion promoters (A) are aminosilanes, such as 3-aminopropyltrimethoxysilane, 3-aminopropyltriethoxysilane, 3-aminopropylmethyldimethoxysilane, 3-aminopropylmethyldiethoxysilane, N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, N-(2-aminoethyl)-3-aminopropyltriethoxysilane, cyclohexylaminomethyltriethoxysilane, cyclohexylaminomethylmethyldiethoxysilane, cyclohexylaminomethyltriethoxysilane, 3-cyclohexylaminomethyltrimethoxysilane, cyclohexylaminomethyltrimethoxysilane, and cyclohexylaminomethylmethyldimethoxysilane, epoxysilanes such as glycidyloxypropyltrimethoxysilanes, glycidyloxypropylmethyldimethoxysilane, glycidyloxypropyltriethoxysilane or glycidyloxypropylmethyldiethoxysilane. Other silanes as well having organic functional groups, such as, for example, 2-(3-triethoxysilylpropyl)maleic anhydride, N-(3-trimethoxysilylpropyl)urea, N-(3-triethoxysilylpropyl)urea, N-(trimethoxysilylmethyl)urea, N-(methyldimethoxysilylmethyl)urea, N-(3-triethoxysilylmethyl)urea, N-(3-methyldiethoxysilylmethyl)urea, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, 3-methacryloyloxypropyltrimethoxysilane, methacryloyloxymethyltrimethoxysilane, methacryloyloxymethylmethyldimethoxysilane, methacryloyloxymethyltriethoxysilane, methacryloyloxymethylmethyldiethoxysilane, 3-acryloyloxypropyltrimethoxysilane, acryloyloxymethyltrimethoxysilane, acryloyloxymethylmethyldimethoxysilanes, acryloyloxymethyltriethoxysilane and acryloyloxymethylmethyldiethoxysilane, may be used as adhesion promoters.

The coating composition (C) comprises one or more adhesion promoters (A) in amounts of preferably at least 0.01% by weight, more preferably at least 0.5% by weight, and preferably not more than 10% by weight, more preferably not more than 5% by weight.

Where aminosilanes are used as curing catalysts (K), they also serve preferably as adhesion promoters (H) at the same time. The amount of aminosilanes in the coating compositions of the invention is preferably at least 0.01% by weight, more preferably at least 0.5% by weight, and preferably not more than 5% by weight, more preferably not more than 3% by weight.

In one particularly preferred embodiment of the invention the coating composition (C) of the invention also comprises silanes (S) of the general formula (II)

R³R⁴N—CH₂—Si (OR¹)ₓR²₃₋ₓ (II),

in which

R³ is hydrogen or a linear, cyclic or branched, optionally substituted alkyl group having 1 to 10 carbon atoms,

R⁴ is a linear, cyclic or branched, optionally substituted alkyl or alkenyl group having 1 to 10 carbon atoms or an optionally substituted aryl or arylalkyl group having 6 to 10 carbon atoms, and R¹, R², and x have the definition indicated for formula (I).

R³ here is preferably hydrogen, while R⁴ is preferably a linear, branched or cyclic alkyl group having 1 to 10 carbon atoms or an aryl or arylalkyl group having 6 to 10 carbon atoms.

With particular preference the silanes (S) possess structures of the formula (III)

cyclohexyl-HN—CH₂—Si (OR¹)ₓR²₃₋ₓ (III),

where R¹, R², and x have the definition indicated for formula (I).

The composition (C) comprises preferably at least 0.1% by weight, more preferably at least 0.5% by weight, and preferably not more than 10% by weight, more preferably not more than 5% by weight, and very preferably not more than 4% by weight, of one or more silanes (S).

The silanes (S) conforming to the formula (II) or (III) serve here to lower the viscosity of the composition (C). Thus the addition of this component results in a substantially more significant reduction in viscosity than the addition of other monomers of comparable molar mass. The reason for this remarkable and entirely surprising effect is not known. Nevertheless, this effect is extremely desirable, since it significantly improves the ease of application of the mixture, which is accomplished usually by rolling or spraying.

The silanes (S) may also, moreover, serve as curing catalysts, plasticizers and/or adhesion promoters.

The coating compositions may comprise further substances customary for moisture-curing coating compositions.

The coating composition (C) of the invention may comprise one or more plasticizers such as phthalic esters (e.g., dioctyl phthalate, diisooctyl phthalate, diundecyl phthalate), adipic esters (e.g., dioctyl adipate), benzoic esters, glycol esters, esters of saturated alkanediols (e.g., 2,2,4-trimethyl-1,3-pentanediol monoisobutyrates, 2,2,4-trimethyl-1,3-pentanediol diisobutyrates), phosphoric esters, sulfonic esters, polyesters, polyethers, polystyrenes, polybutadienes, polyisobutylenes, paraffinic hydrocarbons, and branched hydrocarbons of high molecular mass. The total amount of all plasticizers present in the composition (C) is preferably at least 5% by weight, more preferably at least 10% by weight, and preferably not more than 60% by weight, more preferably not more than 55% by weight, and very preferably not more than 40% by weight.

The coating formulation (C) of the invention may comprise one or more rheological additives, such as, for example, hydrophilic fumed silica, coated hydrophobic fumed silica, precipitated silica, polyamide waxes, hydrogenated castor oils, stearates, and precipitated calcium carbonates, these additives being used in amounts of preferably at least 0.1% by weight, more preferably at least 0.5% by weight, and preferably not more than 10% by weight, more preferably not more than 5% by weight.

The coating formulation (C) of the invention may additionally comprise stabilizers, such as light stabilizers (e.g., HALS compounds), fungicides, flame retardants, pigments, solvents, or other additives typical for one-component, silane-crosslinking systems.

The following coating composition (C) is preferred:

5% to 25%, preferably 5% to 20%, by weight of silane-terminated polymers (P)

10% to 70% by weight of calcium carbonate, mica or talc

0.5% to 4% by weight of water scavengers (W)

0.05% to 3% by weight of curing catalysts (K), more particularly tin-free curing catalysts

0.1% to 5% by weight of adhesion promoters (A)

0% to 55% by weight of plasticizers

0% to 5% by weight of rheological additives

0% to 5% by weight of stabilizers and pigments

0% to 30% by weight of flame retardants

0% to 20% by weight of solvents, the total amounts adding up to 100% by weight.

The coating compositions may be prepared by techniques and mixing methods of the kind customary for producing moisture-curing coating compositions.

The method of the invention is suitable for sealing surfaces against the penetration of water. It is suitable for sealing surfaces of exterior building surfaces, interior building areas (e.g., in wet rooms, where the coated surfaces may subsequently also be additionally covered with tiles or other decorative materials), roofs, and the like. The method of the invention may also serve to equip the surfaces in question with a barrier against the diffusion of water vapor. Similarly, it may serve to provide the areas treated accordingly with acoustic insulation. The coating compositions of the invention may therefore also be used as damping and acoustic-insulation material.

With the method of the invention, the coating composition (C) is applied preferably by means of brush, roller, doctor or commercial spraying equipment such as airless equipment.

The coating compositions of the invention are applied preferably in a film thickness of 0.1 to 5 mm.

Examples of surfaces to which the coating compositions of the invention may be applied are mineral building materials, metals, roofing felts, plastics, woven fiber fabrics, glass or ceramic. The coating compositions of the invention exhibit thixotropic behavior and may be applied both to horizontal and to vertical areas.

The coating compositions of the invention are preferably applied to the surfaces to be coated, and caused to cure. Curing takes place preferably at temperatures of 0 to 50° C., more preferably 10 to 40° C., and under the pressure of the surrounding atmosphere (approximately 1020 hPa). Curing may also take place, however, at higher or lower pressures.

The coatings obtained after curing are notable for outstanding elasticity, high weathering stability, and good recoatability.

All of the above symbols in the above formulae have their definitions in each case independently of one another. In all formulae the silicon atom is tetravalent.

The examples below serve to illustrate the invention without restricting it. Unless indicated otherwise, all amounts and percentages are by weight, all pressures are 0.10 MPa (abs.), and all temperatures 20° C. The expression “% by weight” refers always, without exception, to the entire coating composition (C).

Example 1:

100 g (10% by weight) of GENIOSIL® STP-E10 (a polypropylene glycol with end groups of the formula (I) with A=methylene radical, R¹=methyl radical, R²=methyl radical, and x=2; available commercially from Wacker Chemie AG), 500 g (50% by weight) of diisodecyl phthalate, and 20 g (2% by weight) of vinyltrimethoxysilane (GENIOSIL® XL 10, Wacker Chemie AG) are introduced into a planetary mixer (LabMax, PC-Laborsystem) and mixed at 400 rmin⁻¹ and under atmospheric pressure at room temperature for 2 minutes. Then 330 g (33% by weight) of ground calcium carbonate (BLR3, OMYA) are added and are incorporated at 600 rmin⁻¹ and under atmospheric pressure for 3 minutes.

Thereafter 20 g (2% by weight) of hydrophobic fumed silica (HDK® H18, Wacker Chemie AG) are placed into the mixer, followed by mixing at 200 rmin⁻¹ and under atmospheric pressure for 2 minutes and then at 600 rmin⁻¹ and 100 mbar for 2 minutes. Lastly, 30 g (3% by weight) of 3-aminopropyltrimethoxysilane (GENIOSIL® GF 96, Wacker Chemie AG) are added to the mixture, and mixing takes place at 600 rmin⁻¹ and 100 mbar for 3 minutes. The formulation is dispensed into 310 ml cartridges and stored for 24 hours.

Example 2:

190 g (19% by weight) of GENIOSIL® STP-E30 (a polypropylene glycol with end groups of the formula (I) with A=methylene radical, R¹=methyl radical, R²=methyl, and x=2; available commercially from Wacker Chemie AG), 180 g (18% by weight) of 2,2,4-trimethyl-1,3-pentanediol diisobutyrates (TXIB, Eastman), 15 g (1.5% by weight) of vinyltrimethoxysilane (GENIOSIL® XL 10, Wacker Chemie AG), and 5 g (0.5% by weight) of O-methylcarbamatomethylmethyldimethoxysilane (GENIOSIL® XL 65, Wacker Chemie AG) are introduced into a planetary mixer (LabMax, PC-Laborsystem) and mixed at 400 rmin⁻¹ and under atmospheric pressure at room temperature for 2 minutes. Then 600 g (60% by weight) of ground calcium carbonate (ImerSeal 50, Imerys) are added and are incorporated at 600 rmin⁻¹ and under atmospheric pressure for 3 minutes. Thereafter 5 g (0.5% by weight) of hydrophilic fumed silica (HDK® N20, Wacker Chemie AG) are placed into the mixer, followed by mixing at 200 rmin⁻¹ and under atmospheric pressure for 2 minutes and then at 600 rmin⁻¹ and 100 mbar for 2 minutes. Lastly, 5 g (0.5% by weight) of 3-aminopropyltrimethoxysilane (GENIOSIL® GF 96, Wacker Chemie AG) are added to the mixture, and mixing takes place at 600 rmin⁻¹ and 100 mbar for 3 minutes. The formulation is dispensed into 310 ml cartridges and stored for 24 hours.

Example 3:

150 g (15% by weight) of GENIOSIL® STP-E35 (a polypropylene glycol with end groups of the formula (I) with A=methylene radical, R¹=methyl radical, R²=methyl radical, and x=3; available commercially from Wacker Chemie AG), (GENIOSIL® STP-E35, Wacker Chemie AG), 230 g (23% by weight) of diisodecyl phthalate, and 20 g (2% by weight) of vinyltrimethoxysilane (GENIOSIL® XL 10, Wacker Chemie AG) are introduced into a planetary mixer (LabMax, PC-Laborsystem) and mixed at 400 rmin⁻¹ and under atmospheric pressure at room temperature for 2 minutes. Then 559.5 g (55.95% by weight) of ground calcium carbonate (ImerSeal 50, Imerys) are added and are incorporated at 600 rmin⁻¹ and under atmospheric pressure for 3 minutes. Thereafter 10 g (1% by weight) of hydrophobic fumed silica (HDK® H18, Wacker Chemie AG) are placed into the mixer, followed by mixing at 200 rmin⁻¹ and under atmospheric pressure for 2 minutes and then at 600 rmin⁻¹ and 100 mbar for 2 minutes. Lastly, 30 g (30% by weight) of 3-aminopropyltrimethoxysilane (GENIOSIL® GF 96, Wacker Chemie AG) and 0.5 g (0.05% by weight) of dibutyltin dilaurate are added to the mixture, and mixing takes place at 600 =rmin⁻¹ and 100 mbar for 3 minutes. The formulation is dispensed into 310 ml cartridges and stored for 24 hours.

Example 4:

Water absorption testing of bricks coated with the compositions of the invention:

For this test, solid format bricks (23.5×11.5×7 cm) from Schlagmann are dedusted with compressed air and, with glass strips 2 mm thick and 1.5 cm wide, a stencil is placed on in each case. The coating compositions from examples 1 to 3 are each introduced into these stencils, and are uniformly spread and drawn down using a drawing blade or filling knife. The completed test specimens are subsequently stored at 25° C. and 50% relative humidity for 14 days.

Following this storage, the stencil is removed and the coating (20.5×8.0×0.2 cm) is examined for any damage. The remaining free region of the brick is then coated with a specific sealant (EL1ASTOSIL® E10, Wacker Chemie AG) in order to prevent the penetration of the water into the uncoated area. This specialty sealant is also applied over the edge of the brick (to a height of approximately 1 cm), and caused to dry in accordance with manufacturer indications.

The brick is then weighed to determine the starting value. The test specimen, with the coated area downward, is then placed on glass rods into a trough, which is filled with fully demineralized water until the brick is surrounded with water to a height of approximately 0.5 cm. At defined intervals, the specimen is taken from the trough, freed of its adhering water on the coating, using a paper cloth, and then weighed.

The uncoated brick (blank value) had reached its maximum water absorption of 13.5% within 1 hour. The bricks coated with the formulations of the invention from examples 1 to 3 showed no increase in weight even after water storage for 4 weeks, and hence gave a water absorption of 0%.

Comparative experiment 1:

150 g (15% by weight) of MS Polymer (S303H, available commercially from Kaneka Corporation), 230 g (23% by weight) of diisodecyl phthalate, and 20 g (2% by weight) of vinyltrimethoxysilane (GENIOSIL® XL 10, Wacker Chemie AG) are introduced into a planetary mixer (LabMax, PC-Laborsystem) and mixed at 400 rmin⁻¹ and under atmospheric pressure at room temperature for 2 minutes. Then 552.5 g (55.25% by weight) of ground calcium carbonate (ImerSeal 50, Imerys) are added and are incorporated at 600 rmin⁻¹ and under atmospheric pressure for 3 minutes. Thereafter 10 g (1% by weight) of hydrophobic fumed silica (HDK® H18, Wacker Chemie AG) are placed into the mixer, followed by mixing at 200 rmin⁻¹ and under atmospheric pressure for 2 minutes and then at 600 rmin⁻¹ and 100 mbar for 2 minutes. Lastly, 30 g (3% by weight) of 3-aminopropyltrimethoxysilane (GENIOSIL® GF 96, Wacker Chemie AG) and 7.5 g (0.75% by weight) of dibutyltin dilaurate are added to the mixture, and mixing takes place at 600 rmin⁻¹ and 100 mbar for 3 minutes. The formulation is dispensed into 310 ml cartridges and stored for 24 hours.

Comparative experiment 2:

250 g (25% by weight) of MS Polymer (S303H, Kaneka Corporation), 200 g (20% by weight) of diisodecyl phthalate, and 20 g (2% by weight) of vinyltrimethoxysilane (GENIOSIL® XL 10, Wacker Chemie AG) are introduced into a planetary mixer (LabMax, PC-Laborsystem) and mixed at 400 rmin⁻¹ and under atmospheric pressure at room temperature for 2 minutes. Then 489.5 g (48.95% by weight) of ground calcium carbonate (ImerSeal 50, Imerys) are added and are incorporated at 600 rmin^{-I} and under atmospheric pressure for 3 minutes. Thereafter 10 g (1% by weight) of hydrophobic fumed silica (HDK® H18, Wacker Chemie AG) are placed into the mixer, followed by mixing at 200 rmin⁻¹ and under atmospheric pressure for 2 minutes and then at 600 rmin⁻¹ and 100 mbar for 2 minutes. Lastly, 30 g (3% by weight) of 3-aminopropyltrimethoxysilane (GENIOSIL® GF 96, Wacker Chemie AG) and 0.5 g (0.05% by weight) of dibutyltin dilaurate are added to the mixture, and mixing takes place at 600 rmin⁻¹ and 100 mbar for 3 minutes. The formulation is dispensed into 310 ml cartridges and stored for 24 hours.

Comparative experiment 3:

A commercial sealing formulation based on MS Polymer (Bostik Aqua Blocker, bought at Baumarkt Hornbach) was analyzed. The polymer content by thermogravimetry and nuclear magnetic resonance spectroscopy was approximately 25% by weight. The tin content was determined by elemental analysis to be 0.14% by weight, corresponding to an arithmetic dibutyltin dilaurate content of approximately 0.75% by weight.

For the inventive coating compositions of examples 1 to 3 and for the noninventive coating compositions of comparative experiments 1 to 3, the skinover time, the mechanical properties, the tack, and the water vapor diffusion resistance were measured. The results are compiled in the table.

TABLE

| Example or | | | | | | |
|---|---|---|---|---|---|---|
| comparative | | | | | | |
| experiment | Ex. 1 | Ex. 2 | Ex. 3 | Comp. 1 | Comp. 2 | Comp. 3 |
| Polymer | 10 | 19 | 15 | 15 | 25 | 25 |
| content | | | | | | |
| [% by weight] | | | | | | |
| Viscosity | 27 | 85 | 77 | 73 | 73 | 83 |
| [Pa*s] | | | | | | |
| Tin catalyst | 0 | 0 | 0.05 | 0.75 | 0.05 | 0.75 |
| [% by weight] | | | | | | |
| Skinover time | 55 | 27 | 75 | does | weeks | 32 |
| [min] | | | | not | | |
| | | | | cure | | |
| Tensile | 0.4 | 0.9 | 0.7 | — | not | 0.8 |
| strength | | | | | determined | |
| [N/mm²] | | | | | | |
| Elongation at | 330 | 430 | 470 | — | not | 350 |
| break [%] | | | | | determined | |
| Shore A | 10 | 35 | 31 | — | not | 21 |
| | | | | | determined | |
| Tack | tack- | tack- | tack- | — | very tacky | tacky |
| | free | free | free | | | |
| Water vapor | 550 | 510 | 490 | — | not | 530 |
| diffusion | | | | | determined | |
| resistance μ | | | | | | |

Measurement methods:

The viscosity of the compositions was determined using a Brookfield viscometer (spindle 6, 5 Hz). For determination of the mechanical properties, the materials from the examples were introduced into Teflon molds 2 mm deep and were cured at 23° C. and 50% relative humidity for 2 weeks. The mechanical properties of the resultant sheets were determined in accordance with DIN 53504 (tensile strength, elongation at break) and DIN 53505 (Shore hardness). The tack was assessed qualitatively by contacting the sheet. The water vapor diffusion resistance p was determined by means of the wet cup method (ammonium dihydrogenphosphates, gradient 93%/50% relative humidity at 23° C.)

As may be ascertained from the table, the coating compositions of the invention undergo tack-free curing even with a low polymer content of below 20% by weight, and without the accompanying use of tin catalysts. They exhibit good mechanical properties (see examples 1-3). The coating compositions obtained with MS polymers in accordance with the prior art, in the comparative experiments, do not cure, despite the high level of tin catalyst, at low polymer contents below 20% by weight (see comp. 1). If the polymer content is increased to 25% by weight and the tin content is low, the compositions with MS polymer cure only very slowly after weeks, and the surface is very tacky (see comp. 2), and therefore unsuitable for practice. Only if the amount of tin catalysts is increased greatly is curing achieved, the surface still being tacky (see comp. 3).

1. A method for sealing a building surface or roof using a one-component, moisture-curing coating composition (C) comprising 5% to 25% by weight of one or more silane-terminated polymers (P) having end groups of the formula (I)
˜O—C(=O)—NH—A—Si(OR¹)ₓR²₃₋ₓ (I),
in which
A is a linear or branched alkylene group having 1 to 10 carbon atoms,
R¹ is a linear or branched, optionally halogenated alkyl group having 1 to 10 carbon atoms,
R² is a linear or branched, optionally halogenated alkyl group having 1 to 10 carbon atoms, and
x is 1, 2 or 3,
1% to 80% by weight of one or more fillers (F),
0.1% to 10% by weight of one or more water scavengers (W),
0.01% to 5% by weight of one or more curing catalysts (K),
0.01% to 10% by weight of one or more adhesion promoters (A),
where aminosilanes used as curing catalyst (K) in amounts of 0.5 to 5% by weight can simultaneously serve as adhesion promoters (A),
and optionally further substances customary in moisture-curing coating compositions, the amounts by weight adding up to 100%,
with the proviso that the coated surface is sealed against the penetration of water or water vapor.

2. The method of claim 1, wherein A in formula (I) is a methylene radical.

3. The method of claim 1, wherein the coating composition comprises exclusively tin-free curing catalysts as curing catalysts (K).

4. The method of claim 1, wherein the coating composition comprises exclusively metal-free curing catalysts as curing catalysts (K).

5. The method of claim 1, wherein aminosilanes are used as metal-free curing catalysts (K).

6. (canceled)

7. The method of claim 1, wherein calcium carbonate, mica or talc or mixtures thereof are used as fillers (F).

8. (canceled)

9. The method of claim 1, wherein further substances used in the coating composition comprise plasticizers, rheological additives, stabilizers, pigments, flame retardants or solvents.

10-11. (canceled)

12. A method for sealing a surface, wherein the coating composition of claim 1 is applied to the surface to be coated, and is caused to cure.

13. The method of claim 2, wherein the coating composition comprises exclusively tin-free curing catalysts as curing catalysts (K).

14. The method of claim 2, wherein the coating composition comprises exclusively metal-free curing catalysts as curing catalysts (K).

15. The method of claim 2, wherein aminosilanes are used as metal-free curing catalysts (K).

16. The method of claim 2, wherein calcium carbonate, mica or talc or mixtures thereof are used as fillers (F).

17. The method of claim 2, wherein further substances used in the coating composition comprise plasticizers, rheological additives, stabilizers, pigments, flame retardants or solvents.

18. A method for sealing a surface, wherein the coating composition of claim 2 is applied to the surface to be coated, and is caused to cure.
